(19) United States
(12) Patent Application Publication
(10) Pub. No.: US 2012/0065967 A1
(43) Pub. Date: Mar. 15, 2012

(54) COMMUNICATION DEVICE AND SIGNAL PROCESSING METHOD

(75) Inventor: Masato Ohkawa, Toyama (JP)

(73) Assignee: PANASONIC CORPORATION, Osaka (JP)

(21) Appl. No.: 13/321,730

(22) PCT Filed: Feb. 19, 2010
(86) PCT No.: PCT/JP2010/001094

§ 371 Date: Nov. 21, 2011

(30) Foreign Application Priority Data
May 27, 2009 (JP) 2009127794

(51) Int. Cl. G10L 19/14

(52) U.S. Cl. 704/225; 704/E19.039

(57) ABSTRACT

Provided is a communication device which can easily provide a function to enable signal cross-reference among a plurality of voice signals having different frequency ranges and to enhance the quality of voice communications, at a low cost. In the communication device, a band expansion unit (104) expands a narrow band voice signal to a broad frequency range voice signal; a gain control unit (105) controls a gain of a downstream voice signal using an upstream voice signal as a reference signal; an echo canceler (109) cancels an echo component contained in the upstream voice signal using the downstream voice signal as a reference signal; a down-sampling unit (111) generates a narrow band reference signal by performing a band conversion to convert a broad band voice signal to a narrow band voice signal; and an up-sampling unit (112) generates a broadband reference signal by performing band conversion to convert a narrow band voice signal to a broadband voice signal.

### TECHNICAL FIELD

The present invention relates to a communication apparatus and a signal processing method. More particularly, the present invention relates to a communication apparatus and a signal processing method used in a communication system in which signals having a plurality of different frequency bands are present together.

### BACKGROUND ART

Recently, a mobile terminal such as a mobile phone has been spreading rapidly, and a mobile phone has replaced a land-line telephone and has been essential in daily live.

A wideband code division multiple access (W-CDMA) scheme has been spreading as a 3rd generation mobile phone scheme, and a communication service using a high speed downlink packet access (HSDPA) scheme and a high speed uplink packet access (HSUPA) scheme which are higher-speed schemes than W-CDMA, has been starting.

Speech communication of these schemes employs a narrowband speech coding scheme using a sampling rate of 8 kHz represented by an adaptive multi-rate (AMR).

In speech communication, sufficient quality can be acquired by a narrowband speech coding scheme such as AMR. On the other hand, a narrowband speech coding scheme such as AMR has an insufficient sampling rate compared to a music compact disc (44.1 kHz) and so on, and only supports speech signals having a frequency band of 4 kHz or lower. When a communication service using a higher-speed communication scheme starts in the future, a wideband speech coding scheme referred to as AMR-wideband (AMR-WB) (having a 16 kHz sampling rate) is planned to be used.

There, an art related to a communication system using a wideband speech coding scheme such as AMR-WB is being studied. For example, there is an art to support both a wideband speech having a band speech over 4 kHz and a narrowband speech having a band speech of 4 kHz or lower in a wideband communication system using AMR-WB (see, patent literature 1).

### Citation List

### Patent Literature

### PTL 1

### Japanese Patent Application Laid-Open No. 2005-258226

### SUMMARY OF INVENTION

### Technical Problem

Assuming using an art which can support speech signals having a plurality of different frequencies as shown in the above patent literature 1, in a mobile terminal, signals having different frequencies are present together between an upstream speech signal (a transmission speech signal) and a downstream speech signal (a reception speech signal).

Also, when improving communication speech quality by extending a narrowband speech signal to a wide band, signals of a plurality of different frequencies are similarly present together.

Also, generally, various functions are often provided in a mobile terminal to improve communication quality of speech communication in the mobile terminal. For example, functions such as a noise canceller to reduce noise and make a conversational speech easier to hear, and an echo canceller to cancel the echo which is picked up from the microphone side upon a hands-free call and so on are generally known. It is difficult to carry out these functions by only adding some processing to a part of downstream speech processing or upstream speech processing, and there are cases where a signal reference from an upstream speech signal to a downstream speech signal or a signal reference from a downstream speech signal to an upstream speech signal is required. In such a case, if signals having a plurality of different frequency bands are present together between an upstream speech signal and a downstream speech signal, it is not possible to reference signals mutually between the upstream speech signal and the downstream speech signal.

It is therefore an object of the present invention to provide a communication apparatus and a signal processing method which make it possible to reference signals mutually between a plurality of speech signals having different frequency bands and to provide a function to improve speech communication quality easily, at a low cost.

### Solution to Problem

A communication apparatus according to the present invention employs a configuration to include a signal processing section that performs signal processing on one of a downstream speech signal and an upstream speech signal, using one of the upstream speech signal and the downstream speech signal as a reference signal, and a conversion section that converts a frequency band of a signal used for the reference signal and matches a frequency band of the reference signal and a frequency band of the signal which is subject to signal processing in the signal processing section.

A signal processing method according to the present invention employs a configuration to include a signal processing step of performing signal processing on one of a downstream speech signal and an upstream speech signal, using one of the upstream speech signal and the downstream speech signal as a reference signal, and a conversion step of converting a frequency band of a signal used for the reference signal and matching a frequency band of the reference signal and a frequency band of the signal which is subject to signal processing in the signal processing step.

### Advantageous Effects of Invention

The present invention makes it possible to reference signals mutually between a plurality of speech signals having different frequency bands and to provide a function to improve speech communication quality easily, at a low cost.

### BRIEF DESCRIPTION OF THE DRAWINGS

FIG. 1 is a block diagram showing the configuration of the communication apparatus according to embodiment 1 of the present invention;

FIG. 2 is a block diagram showing the configuration of the communication apparatus according to embodiment 2 of the present invention;

FIG. 3 is a block diagram showing the configuration of the communication apparatus according to embodiment 3 of the present invention; and

FIG. 4 is a block diagram showing the configuration of the communication apparatus according to embodiment 4 of the present invention.

### DESCRIPTION OF EMBODIMENT

Now, embodiments of the present invention will be explained with reference to the accompanying drawings.

### Embodiment 1

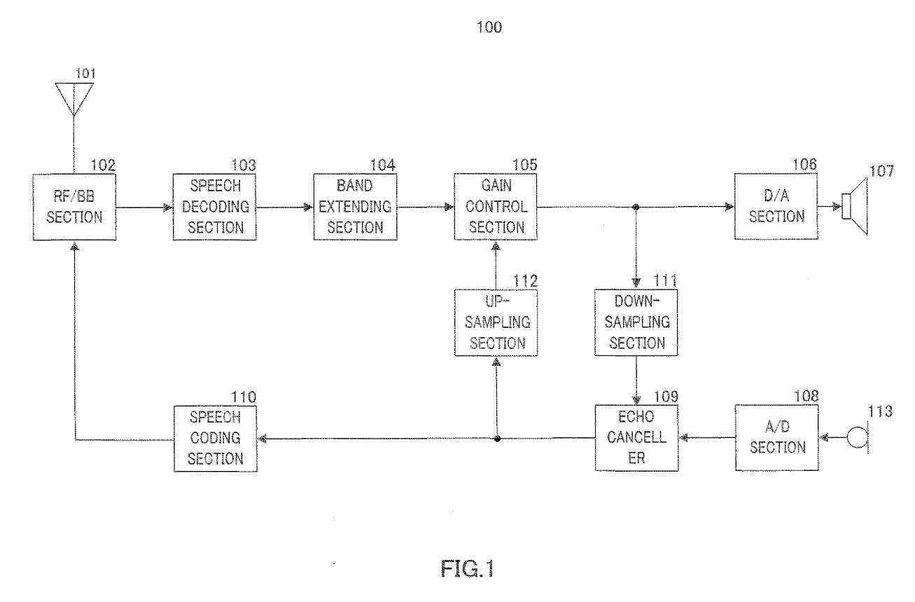

FIG. 1 shows the configuration of communication apparatus 100 according to the present embodiment.

In communication apparatus 100, radio frequency (RF)/base band (BB) section 102 performs radio processing between a radio frequency and a base band including up-conversion and down-conversion on a speech signal which is received and transmitted via antenna 101.

Speech decoding section 103 performs decoding processing on a downstream speech signal (a narrowband speech signal) after radio processing. For example, AMR is used as a decoding scheme. There are a narrowband scheme (an AMR-NR scheme) and a wideband scheme (an AMR-WB scheme) in AMR. The present embodiment uses, for example, an ARM-NB scheme.

Band extending section 104 performs band extension from a narrowband speech signal to a wideband speech signal, and reconstructs a high band part of a speech signal which is lost upon coding in a communicating party terminal.

Gain control section 105 controls the gain of a downstream speech signal (a wideband speech signal) in order to hear a speech easily. This gain control makes it possible to improve speech communication quality of a downstream speech signal. Gain control section 105 controls the gain of a downstream speech signal (a wideband speech signal) input from band extending section 104 using an upstream speech signal (a wideband speech signal) input from up-sampling section 112 as a reference signal. For example, gain control section 105 performs gain control so as to increase the gain in order to hear a speech easily when the upstream speech signal includes more ambient noise.

D/A section 106 converts a digital speech signal into an analog speech signal and outputs an analog speech signal to output device 107 such as a receiver, a speaker, and a headset.

A/D section 108 converts an analog speech signal input from microphone 113, into a digital speech signal.

Echo canceller 109 cancels and controls an echo component to a communicating party terminal, which is generated when output speech from output device 107 is picked up by microphone 113. By this echo cancellation, it is possible to improve speech communication quality of an upstream speech signal. Echo canceller 109 cancels an echo component included in an upstream speech signal (a narrowband speech signal) input from A/D section 108 using a downstream speech signal (a narrowband speech signal) input from down-sampling section 111 as a reference signal.

Speech coding section 110 performs coding processing on an upstream speech signal (a narrowband speech signal). For example, AMR is used as a coding scheme. There are a narrowband scheme (an AMR-NR scheme) and a wideband scheme (an AMR-WB scheme) in AMR. The present embodiment uses, for example, an ARM-NB scheme.

Down-sampling section 111 performs band conversion from a wideband speech signal input from gain control section 105, to a narrowband speech signal in order to generate a narrowband downstream speech signal required for a reference signal in echo canceller 109. For example, when a wideband speech signal having a sampling frequency of 16 kHz is input, down-sampling section 111 performs down-sampling and outputs a narrowband speech signal of 8 kHz. By this means, it is possible to match the frequency band of a reference signal in echo canceller 109 and the frequency band of an upstream speech signal which is subject to signal processing in echo canceller 109, to a narrowband.

Up-sampling section 112 performs band conversion from a narrowband speech signal input from echo canceller 109 to a wideband speech signal in order to generate a wideband upstream speech signal required for a reference signal in gain control section 105. For example, when a narrowband speech signal having a sampling frequency of 8 kHz is input, up-sampling section 112 performs up-sampling and outputs a wideband speech signal of 16 kHz. By this means, it is possible to match the frequency band of a reference signal in gain control section 105 and the frequency band of a downstream speech signal which is subject to signal processing in gain control section 105, to a wide band. Up-sampling section 112 may reconstruct a high band signal component in conjunction with up-sampling.

Although a case where a downstream speech signal is a narrowband speech signal and an upstream speech signal is a wideband speech signal has been described above as an example, the present invention is equally applicable to a case where a downstream speech signal is a wideband speech signal and an upstream speech signal is a narrowband speech signal. That is, the present invention is applicable to all cases where it is necessary to reference signals mutually between a plurality of speech signals having different frequency bands.

As described above, the present embodiment converts the frequency bands of a downstream speech signal and an upstream speech signal mutually, having different frequency bands each other and matches the frequency bands of both a narrow band and a wide band. Accordingly, the present embodiment makes it possible to perform gain control to improve speech communication quality of a downstream speech signal by referencing an upstream speech signal and perform echo cancellation to improve speech communication quality of an upstream speech signal by referencing a downstream speech signal. That is, the present embodiment makes it possible to reference signals mutually between a plurality of speech signals having different frequency bands, thereby providing a function to improve speech communication quality, easily, at a low cost.

### Embodiment 2

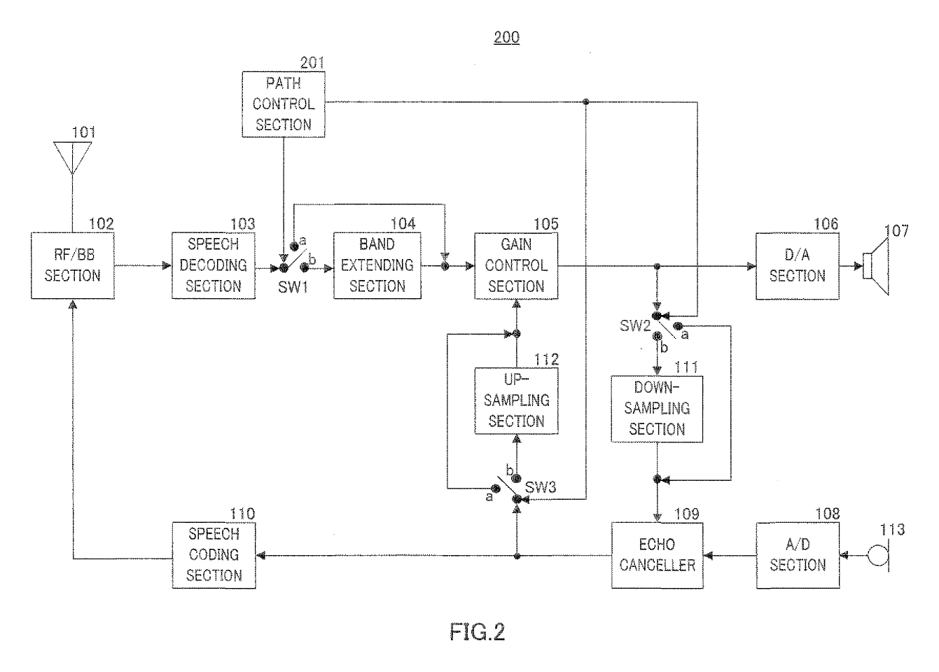

FIG. 2 shows the configuration of communication apparatus 200 according to the present embodiment. Here, in FIG. 2, parts that are the same as in FIG. 1 (embodiment 1) will be assigned the same reference numerals as in FIG. 1 without further explanations.

In communication apparatus 200, path control section 201 controls whether or not to perform band extension in band extending section 104. Path control section 201 controls whether or not to perform down-sampling in down-sampling section 111 and up-sampling in up-sampling section 112, according to whether or not to perform band extension.

To be more specific, when band extension is performed in band extending section 104, path control section 201 connects SW1 (a switch), SW2, and SW3 to the b side and makes activate a path to band extending section 104, a path to down-sampling section 111, and a path to up-sampling section 112. Accordingly, when band extension of a downstream speech signal is performed, the same operation as embodiment 1 (FIG. 1) is performed.

By contrast with this, when band extension is not performed in band extending section 104, it is not necessary to convert the frequency bands of a downstream speech signal and an upstream speech signal mutually. Therefore, path control section 201 connects all of SW1, SW2, and SW3 to the a side and makes inactivate a path to band extending section 104, a path to down-sampling section 111, and a path to up-sampling section 112. By this, a narrowband downstream speech signal is directly input to echo canceller 109 as a reference signal and a narrowband upstream speech signal is directly input to gain control section 105 as a reference signal. Accordingly, when band extension in band extending section 104 is not performed, there is only a narrowband signal in a speech signal in communication apparatus 200.

Path control section 201 may switch whether or not to perform band extension in band extending section 104 in accordance with a key operation of a user in communication apparatus 200 and so on. Also, path control section 201 may switch whether or not to perform band extension in band extending section 104 in synchronization with switching of input and output devices of communication apparatus 200 or hardware such as a peripheral apparatus.

As described above, according to the present embodiment, it is possible to change speech quality according to, for example, preference of a user of a communication apparatus by switching whether or not to perform band extension of a speech signal. Accordingly, besides the effect of embodiment 1, the present embodiment makes it possible to provide a communication apparatus which can be applicable to both a narrowband communication system and a wideband communication system.

### Embodiment 3

In the present embodiment, a case where an analog speech signal input from microphone 113 to A/D section 108 is a wideband speech signal will be explained.

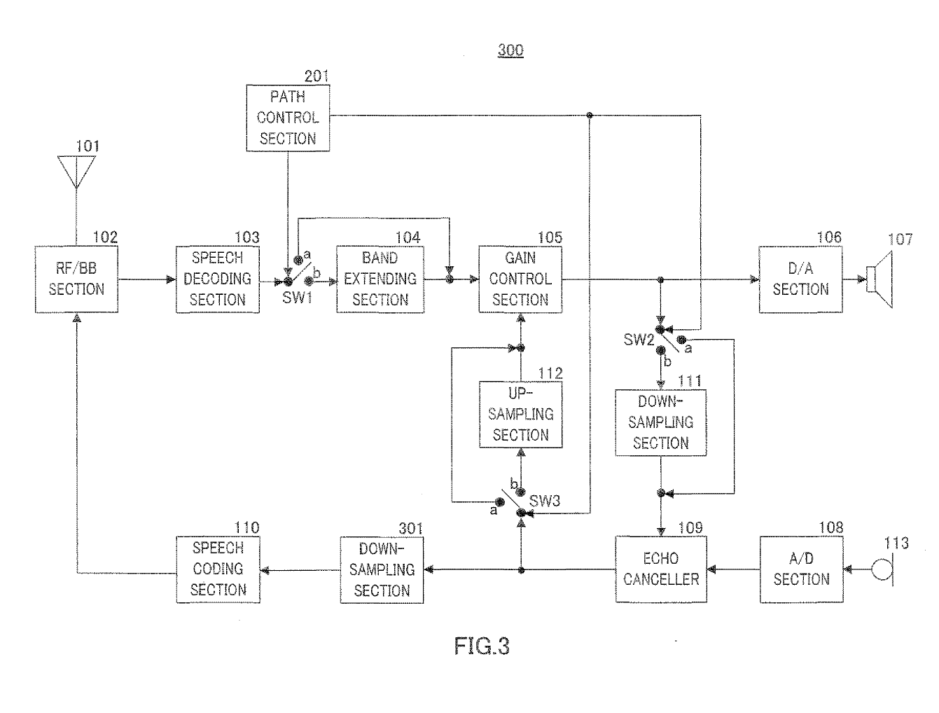

FIG. 3 shows the configuration of communication apparatus 300 according to the present embodiment. Here, in FIG. 3, parts that are the same as in FIG. 1 (embodiment 1) and FIG. 2 (embodiment 2) will be assigned the same reference numerals as in FIG. 1 and FIG. 2 without further explanations.

In communication apparatus 300, when band extension in band extending section 104 is performed, path control section 201 connects SW1 to the b side and makes activate a path to band extending section 104. Also, since an analog speech signal input from microphone 113 to A/D section 108 is a wideband speech signal, it is not necessary to convert the frequency bands of a downstream speech signal and an upstream speech signal mutually. Path control section 201 connects SW2 and SW3 to the a side and makes inactivate a path to down-sampling section 111 and a path to up-sampling section 112. By this, a wideband downstream speech signal is directly put to echo canceller 109 as a reference signal and a wideband upstream speech signal is directly input to gain control section 105 as a reference signal.

On the other hand, when band extension in band extending section 104 is not performed, path control section 201 connects all of SW1, SW2, and SW3 to the a side and makes inactivate a path to band extending section 104, a path to down-sampling section 111, and a path to up-sampling section 112 in line with embodiment 2.

Down sampling section 301 performs band conversion to convert a frequency hand of an upstream speech signal (a wideband speech signal) input from echo canceller 109 into a narrowband speech signal.

As described above, even when a speech signal input from a microphone is a wideband speech signal, the present embodiment makes it possible to achieve the same effect as embodiment 2.

### Embodiment 4

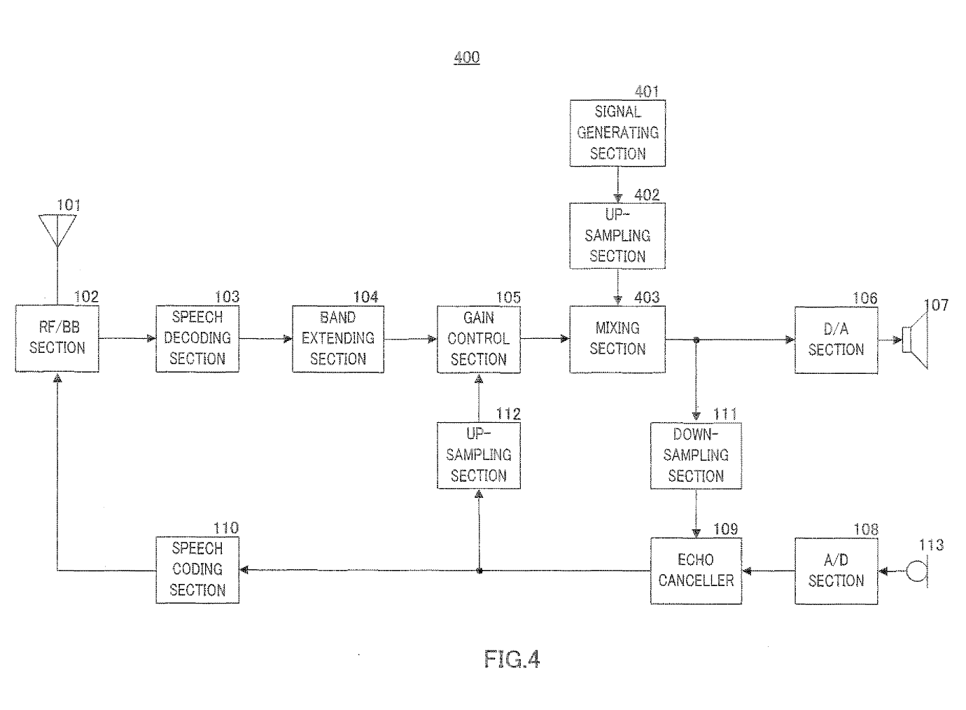

FIG. 4 shows the configuration of communication apparatus 400 according to the present embodiment. Here, in FIG. 4, parts that are the same as in FIG. 1 (embodiment 1) will be assigned the same reference numerals as in FIG. 1 without further explanations.

Signal generating section 401 generates an arbitrary signal such as a sin wave and a tone. Here, signal generating section 401 generates, for example, a narrowband speech signal of 8 kHz.

Up-sampling section 402 performs band conversion to convert a narrowband speech signal input from signal generating section 401 into a wideband speech signal in order to match the frequency band of the narrowband speech signal input from signal generating section 401 and the frequency band of a downstream speech signal (a wideband speech signal) input from gain control section 105 to mixing section 403.

Mixing section 403 mixes (superimposes) a downstream speech signal (a wideband speech signal) input from gain control section 105 and a wideband speech signal input from up-sampling section 402 (that is, speech signals of a plurality of channels) to provide one channel signal.

As long as mixing section 403 is located subsequent to band extending section 104, the position of mixing section 403 is not limited.

Also, it is possible to mix a wideband speech signal and a narrowband speech signal such as an upstream speech signal. In this case, as shown in FIG. 3, a signal generating section which generates a wideband speech signal, a down-sampling section which performs band conversion to convert a wideband speech signal input from the signal generating section into a narrowband speech signal, and a mixing section may be provided subsequent to A/D section 108.

As described above, the present embodiment makes it possible to superimpose signals having an arbitrary frequency band at an arbitrary position.

Above, the present embodiment has been explained.

Signal processing for a downstream speech signal using an upstream speech signal as a reference signal, may be signal processing other than gain control. Also, signal processing for an upstream speech signal using a downstream speech signal as a reference may be signal processing other than echo cancel.

The disclosure of Japanese Patent Application No. 2009-127794, filed on May 27, 2009, including the specification, drawings and abstract, is incorporated herein by reference in its entirety.

### INDUSTRIAL APPLICABILITY

The present invention is preferable to a mobile terminal such as a mobile phone. Particularly, since in some cases, a wideband technology is used to improve speech communication quality when a narrowband coding method such as AMR-NB is used, it is useful to resolve the difference of frequency bands as the present invention.

### REFERENCE SIGNS LIST

100, 200, 300, 400 Communication apparatus
101 Antenna
102 RF/BB section
103 Speech decoding section
104 Band extending section
105 Gain control section
106 D/A section
107 Output device
108 A/D section
109 Echo canceller
110 Speech coding section
111, 301 Down-sampling section
112, 402 Up-sampling section
201 Path control section
401 Signal generating section
403 Mixing section

1-3. (canceled)

4. A communication apparatus comprising:
a band extending section that extends a band of a downstream speech signal;
a gain control section that changes a gain of an output of the band extending section with reference to a first reference signal;
a down-sampling section that performs frequency conversion to narrow a frequency band of the output of the gain control section to use the converted signal as a second reference signal;
an echo canceller section that cancels an echo of an upstream speech signal having a narrower frequency band than the output of the band extending section with reference to the second reference signal; and
an up-sampling section that performs frequency conversion to widen a frequency band of the output of the echo canceller section to use the converted signal as the first reference signal.

5. The communication apparatus according to claim 4, wherein, when making the band extending section inactivate, the communication apparatus makes the down-sampling section and the up-sampling section inactivate.

6. A signal processing method in a communication apparatus comprising:
a band extending step of extending a band of a downstream speech signal;
a gain control step of changing a gain of an output of the band extending step with reference to a first reference signal;
a down-sampling step of performing frequency conversion to narrow a frequency band of the output of the gain control step to use the converted signal as a second reference signal;
an echo canceller step of canceling an echo of an upstream speech signal having a narrower frequency band than the output of the band extending step with reference to the second reference signal; and
an up-sampling step of performing frequency conversion to widen a frequency band of the output of the echo canceller step to use the converted signal as the first reference signal.
